(19) United States
(12) Patent Application Publication
(10) Pub. No.: US 2020/0104801 A1
(43) Pub. Date: Apr. 2, 2020

(54) METHOD FOR ENHANCED SCHEDULE MANAGEMENT BASED ON ROTATION PATTERN AND APPARATUS FOR THE SAME

(71) Applicant: Bespin Global Inc., Seongnam-si (KR)

(72) Inventors: Ah Young KWON, Seongnam-si (KR); Min Sang PARK, Seongnam-si (KR); Jin Young KIM, Seongnam-si (KR)

(73) Assignee: Bespin Global Inc., Seongnam-si (KR)

(21) Appl. No.: 16/173,553

(22) Filed: Oct. 29, 2018

(30) Foreign Application Priority Data
Sep. 27, 2018 (KR) 10-2018-0114758

(51) Int. Cl. G06Q 10/10; G06Q 10/06

(52) U.S. Cl. CPC G06Q 10/1093; G06Q 10/063116; G06Q 10/063118

(57) ABSTRACT

A schedule management method based on a rotation pattern is provided. The schedule management method may include setting a repetition cycle in which a working pattern is repeated, setting a working time with respect to the repetition cycle, generating and displaying a rotation pattern including a repetition pattern of a time block based on the repetition cycle and the working time, assigning at least one worker to the rotation pattern, and generating a schedule including at least one rotation pattern.

### CROSS-REFERENCE TO RELATED APPLICATION(S)

This application claims the benefit of Korean Patent Application No. 10-2018-0114758 filed on Sep. 27, 2018, in the Korean Intellectual Property Office, the disclosure of which is incorporated herein by reference.

### BACKGROUND

### 1. Field of the Invention

One or more example embodiments relate to an enhanced schedule management method based on a rotation pattern or a shift pattern, and an apparatus for the same. More particularly, the present disclosure relates to a schedule generation and management method for utilizing a rotation pattern as a template to provide a user convenience and an intuitive interface when generating a schedule, and relates to an apparatus and an interface for the same.

### 2. Description of the Related Art

Recently, many companies are operating control centers or support centers capable of responding immediately to occurrence of a problem while monitoring services 24 hours a day for 365 days to stably provide services. To maintain a continuity between monitoring of occurrence of a problem and solving of the problem, most companies are adopting a shift work system, and using an alarm management system to manage a schedule management for an efficiency of a shift work.

The alarm management system categorizes alarms generated in connection with a monitoring system according to rules set by a user, performs filtering, and designates, as an incident, an important alarm that needs to be solved. In response to an occurrence of an incident, the incident may spread to persons in charge who provide supports for the incident step by step based on an elapsed time and a processing state and who are responsible for an incident response. Such spreading of the incident is referred to as an “escalation.” In such a schedule or alarm management system, a schedule management function is being provided so that a person in charge who can process an incident based on a shift work situation during an escalation may properly receive a notification.

Since a conventional schedule management system employs a restrict on-call time scheme of setting a length of a shift time, inputting shift workers, and limiting and setting a valid time, it is easy to generate a simply repeated pattern. However, since it is difficult to finely adjust a shape of a time block of a schedule to a shape desired by a user, the user requires more effort and cognitive resources than necessary to generate a desired pattern. Thus, a conventional schedule management method has a limitation in coping with various shift work patterns applied in actual industrial fields.

Therefore, there is a desire for a more enhanced and advanced schedule management system for generating, changing, displaying, and managing a schedule to designate a person in charge who may provide a support for a corresponding incident and who may be responsible for an incident response.

### SUMMARY

Example embodiments provide a schedule management method and apparatus based on a rotation pattern or a shift pattern.

Also, example embodiments provide a method and apparatus for more intuitively and conveniently generating and managing a schedule while increasing a degree of freedom of a user by providing a user interface to input a rotation pattern of a time block applicable in an actual industrial field.

Also, example embodiments provide a method and apparatus for more quickly and conveniently generating a schedule using a rotation pattern template by configuring the schedule to include at least one rotation pattern including a repetition pattern of a time block based on a fact that a shift work operating pattern of a company does not easily change.

Also, example embodiments provide a method and apparatus for storing a repetition pattern of a time block as a template so that the repetition pattern is reused, and for easily generating a desired pattern even though a plurality of layers are not used.

However, problems sought to be solved by the present disclosure are not limited to those described above. Other problems, which are sought to be solved by the present disclosure but are not described herein, will be clearly understood by one of ordinary skill in the art from the following description.

According to an aspect, there is provided a schedule management method based on a rotation pattern which includes setting a repetition cycle in which a working pattern is to repeated, setting a working time with respect to the repetition cycle, generating and displaying a rotation pattern including a repetition pattern of a time block based on the repetition cycle and the working time, assigning at least one worker to the rotation pattern, and generating a schedule including at least one rotation pattern.

The schedule management method may further include storing the generated rotation pattern as a template, and calling at least one of a plurality of rotation patterns that are stored. The generating of the rotation pattern may include setting a working day based on whether the rotation pattern is repeated every day, adding a shift working time based on whether the same length of the shift working time is repeated, and designating an off time.

A length of the time block may be determined based on two or more shift working times with respect to the repetition cycle. A plurality of inputs of the length of the time block may be possible using a block addition button.

The schedule management method may further include determining a suitability of a candidate worker by comparing information of the rotation pattern and a working pattern of the candidate worker.

The schedule management method may further include searching for a time block to which a worker is not assigned from time blocks of the rotation pattern, and searching for a candidate worker corresponding to the time block to which the worker is not assigned.

The schedule management method may further include transmitting a notification message to a found candidate worker and receiving information about an approval or a refusal from the found candidate worker.

The schedule management method may further include setting intensive working time information, and determining whether a worker is changed within an intensive working time.

The schedule management method may further include searching for a time block filled with overtime working hours of a worker from time blocks of the rotation pattern, and searching for a worker substituted for the worker who works overtime.

According to another aspect, there is provided a schedule management apparatus based on a rotation pattern which includes a pattern cycle setter configured to set a repetition cycle in which a working pattern is repeated, a working time setter configured to set a working time with respect to the repetition cycle, a rotation pattern generator configured to generate a rotation pattern including a repetition pattern of a time block based on the repetition cycle and the working time, and an optimizer configured to assign at least one worker to the rotation pattern.

The schedule management apparatus may further include a rotation pattern storage configured to store the generated rotation pattern as a template. The rotation pattern storage may be configured to call at least one of a plurality of rotation patterns that are stored.

The working time setter may be configured to set a working day based on whether the rotation pattern is repeated every day, to add a shift working time based on whether the same length of the shift working time is repeated, and to designate an off time. A length of the time block may be determined based on two or more shift working times with respect to the repetition cycle. A plurality of inputs of the length of the time block may be possible using a block addition button.

The schedule management apparatus may further include an optimizer configured to assign, to the time block, a working time of a mappable candidate worker based on information of the rotation pattern.

The schedule management apparatus may further include a validity checker configured to search for a time block to which a worker is not assigned from time blocks of the rotation pattern, and to search for a candidate worker corresponding to the time block to which the worker is not assigned.

The schedule management apparatus may further include an optimizer configured to transmit a notification message to a found candidate worker and to receive information about an approval or a refusal from the found candidate worker.

The schedule management apparatus may further include a validity checker configured to determine whether a worker is changed within an intensive working time. The working time setter may be configured to set intensive working time information.

The schedule management apparatus may further include a validity checker configured to search for a time block filled with overtime working hours of a worker from time blocks of the rotation pattern, and to search for a worker substituted for the worker who works overtime.

### Effect

According to example embodiments, it is possible to provide a schedule management method and apparatus based on a rotation pattern or a shift pattern.

According to example embodiments, it is possible to provide a method and apparatus for more intuitively and conveniently generating and managing a schedule while increasing a degree of freedom of a user by providing a user interface to input a rotation pattern of a time block applicable in an actual industrial field.

According to example embodiments, it is possible to provide a method and apparatus for more quickly and conveniently generating a schedule using a rotation pattern template by configuring the schedule to include at least one rotation pattern including a repetition pattern of a time block based on a fact that a shift work operating pattern of a company does not easily change.

According to example embodiments, it is possible to provide a method and apparatus for storing a repetition pattern of a time block as a template so that the repetition pattern is reused, and for easily generating a desired pattern even though a plurality of layers are not used.

Effects of the present disclosure are not limited to those described above, and other effects, which are not described herein, will be clearly understood by one of ordinary skill in the art from the following description.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of an enhanced schedule management system based on a rotation pattern according to an example embodiment;

FIG. 2 is a diagram illustrating a basic configuration of a schedule according to an example embodiment;

FIG. 3 is a block diagram illustrating a configuration and a function of a schedule management server according to an example embodiment:

FIG. 4 is a flowchart illustrating an example of an enhanced schedule generation method based on a rotation pattern according to an example embodiment:

FIG. 5 is a flowchart illustrating another example of an enhanced schedule generation method based on a rotation pattern according to an example embodiment;

FIG. 6 is a flowchart illustrating an enhanced rotation pattern generation method according to an example embodiment:

FIG. 7 is a flowchart illustrating a process of assigning a worker (resource) according to an example embodiment;

FIG. 8 is a flowchart illustrating a process of recommending a worker to be assigned to a rotation pattern according to an example embodiment;

FIG. 9 is a diagram illustrating a unit of storage of a schedule according to an example embodiment;

FIG. 10 illustrate setting screens for a shift working time and an off time according to an example embodiment; and

FIG. 11 illustrate screens for setting working days in an equal split rotation pattern according to an example embodiment.

### DETAILED DESCRIPTION

Hereinafter, example embodiments will be described in detail with reference to the accompanying drawings so that inventive concept may be readily implemented by one of ordinary skill in the art. Example embodiments may, however, be embodied in many different forms and should not be construed as being limited to the example embodiments set forth herein.

The terminology used herein is for the purpose of describing example embodiments only and is not intended to be limiting of example embodiments. As used herein, the singular forms are intended to include the plural forms as well, unless the context clearly indicates otherwise.

It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Although terms of “first,” “second,” and the like are used to explain various components, the components are not limited to such terms. These terms are used only to distinguish one component from another component. Also, in the description of example embodiments, detailed description of well-known related structures or functions will be omitted when it is deemed that such description will cause ambiguous interpretation of the present disclosure.

Elements in the following example embodiments are divided by functions thereof for convenience of explanation, but this does not mean that each element is separate from each other element. Thus, two or more elements may be combined into one element that performs the same functions as the two or more elements, or one element may be divided into a plurality of elements that cooperate to perform the same function as the one element. Combination or division of elements is possible within the spirit and scope of the claims and their equivalents.

Hereinafter, example embodiments will be described with reference to the accompanying drawings. A configuration of the present disclosure and the corresponding effect will be clearly understood through the following detailed description.

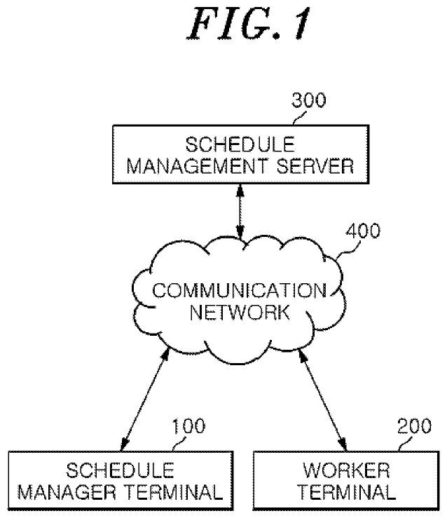

FIG. 1 is a diagram illustrating an example of an enhanced schedule management system based on a rotation pattern according to an example embodiment.

Both a schedule manager terminal 100 used by a schedule manager in charge of a schedule management, and a worker terminal 200 used by a worker of a company may communicate with a schedule management server 300 via a communication network 400. Thus, the schedule manager terminal 100 and the worker terminal 200 may input and transmit required data to the schedule management server 300, or may receive, for example, a notification or a message from the schedule management server 30X).

The communication network 400 may be implemented as all types of wired and wireless networks, for example, a local area network (LAN), a wide area network (WAN), a wireless local area network (WLAN), a personal area network (PAN), a mobile radio communication network, a satellite communication network, and the like, and is not limited thereto.

Each of the schedule manager terminal 100 and the worker terminal 200 may be a terminal that is configured to receive and process a variety of data, and the like over a wired and wireless communication network, and the like, based on an input and output operation of a user, and configured to perform a display. Each of the schedule manager terminal 100 and the worker terminal 200 may include, for example, but are not limited to, one of a personal computer (PC), a desktop computer, a laptop computer, a notebook computer, a smart phone, a tablet computer, a workstation, a personal digital assistant (PDA), a portable computer, a wireless phone, a mobile phone, an e-book, a portable multimedia player (PMP), a portable game console, a navigation system, a black box, a digital camera, a television (TV), a wearable device, a voice recognition speaker, a smart speaker, and an artificial intelligence (AI) speaker.

The schedule management server 300 may include a physical or virtual network device to provide a schedule management service, and may be configured to operate in conjunction with or be integrated with at least one external system, for example, an absenteeism and tardiness attendance management system, an access control system, an e-mail system, an employee management system, a group management system, and a web service system, through an interoperation with another system.

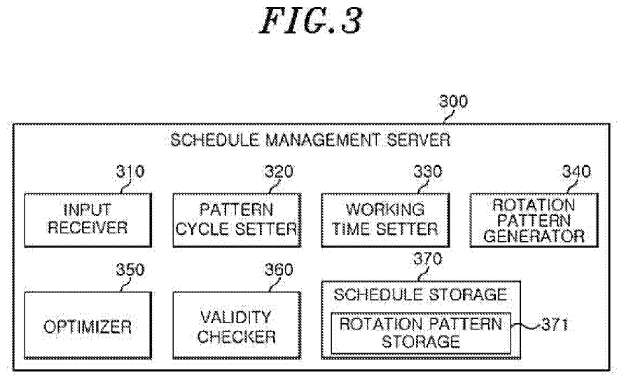

Also, the schedule management server 300 may include, but is not limited to, for example, a PC, a desktop computer, a laptop computer, a network computer, a server device, a network device, a multiprocessor electronic device, and the like. The schedule management server 300 will be further described below with reference to FIG. 3.

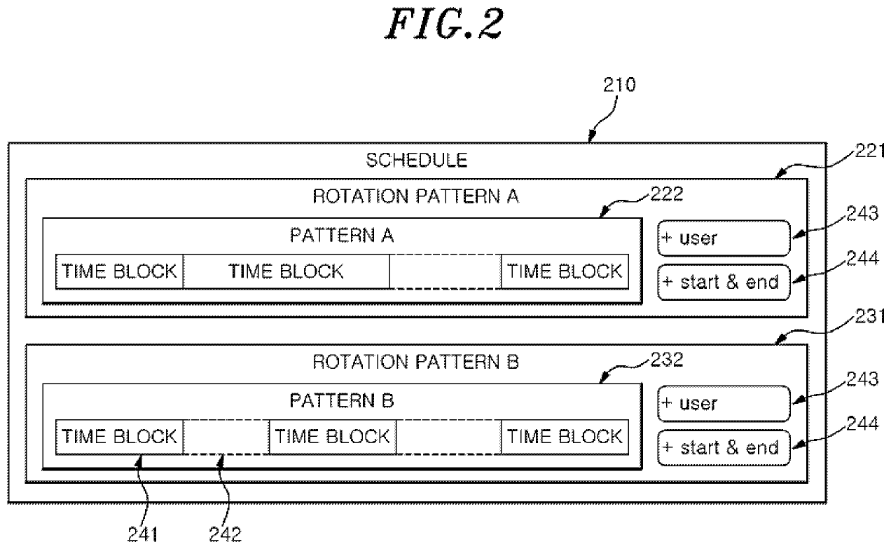

FIG. 2 is a diagram illustrating a basic configuration of a schedule according to an example embodiment.

A schedule 210 may be configured to include one or more rotation patterns, for example, a rotation pattern A 221, and a rotation pattern B 231. In the rotation patterns A 221 and B 231, patterns 222 and 232 are repeated, respectively. Each of the patterns 222 and 232 may include a time block 241 corresponding to a length of a valid time or a shift working time, for example, 10 hours, 12 hours, or 24 hours, and an off time 242 in which working is not performed.

One schedule, e.g., the schedule 210 may include different rotation patterns, e.g., the rotation patterns A 221 and B 231 as shown in FIG. 2. Alternatively, the schedule 210 may include a single rotation pattern.

Each of the rotation patterns A 221 and B 231 may be formed by repeating a pattern of a predetermined cycle, and may be easily repeated and generated using a repeat function. Also, using a user designation button 243, a user or a worker may be easily selected, designated and added. Furthermore, using a start-and-end time designation button 244, a start time and an end time for an application of a corresponding schedule may be designated. The end time may not be input when there is no need to designate the end time.

As described above, according to an example embodiment, a pair of a valid working time (e.g., an on-call time) and an off time that are included in the schedule 210 may be formed as a pattern, and may be separately displayed and stored, and thus it is possible to more intuitively and conveniently generate a rotation schedule with a high degree of freedom of a user based on an environment of an industrial field in which a company's operating pattern of a shift work does not easily change although a worker frequently changes.

FIG. 3 is a block diagram illustrating a configuration and a function of the schedule management server 300 according to an example embodiment.

Referring to FIG. 3, the schedule management server 300 may include an input receiver 310, a pattern cycle setter 320, a working time setter 330, a rotation pattern generator 340, an optimizer 350, a validity checker 360, and a schedule storage 370. The schedule management server 300 may be implemented by integrating or removing a portion of the above components. The input receiver 310, the pattern cycle setter 320, the working time setter 330, the rotation pattern generator 340, the optimizer 350, and the validity checker 360 may include program modules that may be executed by one or more processors. The program modules included in the accompaniment schedule management server 300 may be in the form of operating systems, application program modules, or other program modules, while they may be physically stored on a variety of commonly known storage devices. Such program modules may include, but not limited to, routines, subroutines, programs, objects, components, instructions, data structures, and the like for performing specific tasks or executing specific abstract data types as will be described below in accordance with the present disclosure. The input receiver 310 may function to receive required data from, for example, the schedule manager terminal 100, the worker terminal 200, an external device, or a database (DB), via the communication network 400.

The pattern cycle setter 320 may be configured to set a repetition cycle in which a working pattern is repeated. For example, a cycle of a working pattern may be determined in units of repetition of a pattern, for example, daily, weekly, monthly, every 5 days, every 1 week, every 2 weeks, and the like.

The working time setter 330 may be configured to set a working time with respect to a set work cycle. For example, the working time setter 330 may set a maximum working time or a minimum working time for each work cycle. Also, a shift working time may be input as a repetition of a uniform time unit of, for example, 12 hours or 24 hours, as a shift work of 16 hours (first shift working time) and 8 hours (second shift working time), or as a repetition of a pattern of 16 hours (working time) and 8 hours (off time).

Also, the working time setter 330 may set a restriction time in which working of workers is restricted in a schedule. In the case of a 5-day work week from Monday to Friday, time blocks for Saturday and Sunday may be deactivated. In addition, the working time setter 330 may set restriction time information prior to setting a shift working time, to activate only a time block to which a worker needs to be assigned.

Furthermore, the working time setter 330 may set intensive working time information about an intensive working time in which a change in a worker is not permitted due to a requirement for a focus on a work.

The rotation pattern generator 340 may be configured to generate a rotation pattern including a repetition pattern of a time block based on the repetition cycle and the working time.

The optimizer 350 may be configured to assign at least one worker to the generated rotation pattern, to search for a mappable candidate worker based on information of the rotation pattern, and to assign a working time of a found worker to the time block. The optimizer 350 may map an appropriate worker to the rotation pattern based on attribute information of a worker, for example, duty, a personal schedule, a shift working pattern, and the like.

Also, the optimizer 350 may be configured to transmit a notification message to a candidate worker who is found by the searching and who is to be mapped to a corresponding rotation pattern, and configured to receive information about an approval or a refusal from the candidate worker. When the approval from the candidate worker is confirmed, a working time of the candidate worker may be mapped to a time block of the rotation pattern.

Basically, the optimizer 350 may assign a default working time of a worker mapped to a schedule rotation to a time block. The optimizer 350 may also assign overtime working hours of the worker together with the default working time, if necessary.

The validity checker 360 may be configured to search for a time block to which a worker is not assigned from time blocks of the rotation pattern, and to search for a candidate worker corresponding to the time block to which the worker is not assigned. The optimizer 350 may transmit a notification message to a found candidate worker, and may receive information about an approval or a refusal from the candidate worker.

Also, the validity checker 360 may be configured to search for a time block filled with overtime working hours of a worker from time blocks of the rotation pattern. When a worker works overtime, the validity checker 360 may search for a worker substituted for the worker.

In addition, the validity checker 360 may be configured to determine whether a worker is changed within the intensive working time, based on the intensive working time information set by the working time setter 330. For example, when a worker is changed within the intensive working time, an alarm or a notification message may be provided to a manager.

The schedule storage 370 may be configured to store a schedule including at least one rotation pattern. The schedule storage 370 may store each of a plurality of rotation patterns as a template using a rotation pattern storage 371, to call at least one stored rotation pattern among a plurality of rotation patterns generated by the rotation pattern generator 340 when a schedule is to be generated later.

The schedule storage 370 and the rotation pattern storage 371 may be one or more memory modules including, but not limited to, RAM, ROM, flash memories, hard drives.

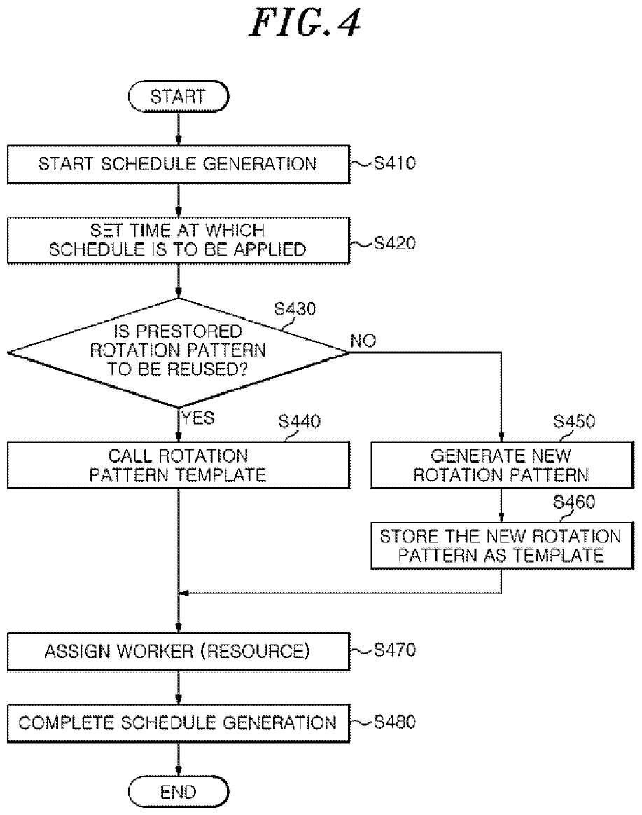

FIG. 4 is a flowchart illustrating an example of an enhanced schedule generation method based on a rotation pattern according to an example embodiment.

When a schedule generation is started in operation S410, a time at which a generated schedule is to be applied may be set in operation S420. A start time and an end time for the time at which a schedule is to be applied may be input. When an end time does not need to be designated, only a start time may be input.

In operation S430, whether to reuse a rotation pattern stored in the rotation pattern storage 371 may be determined. When a prestored rotation pattern is used, a rotation pattern template may be called from the rotation pattern storage 371 in operation S440. When a new rotation pattern is generated instead of using the prestored rotation pattern in operation S450, the new generated rotation pattern may be stored as a template in operation S460.

In operation S470, a worker (resource) may be assigned to a corresponding time block after a setting of a rotation pattern is completed. For an assignment of a worker, a worker may be designated through a search for a worker, or may be selected from a worker recommendation list that is automatically recommended.

In operation S480, the schedule generation may be completed through a setting of a rotation pattern and a worker assignment. A schedule set as needed may be stored and updated.

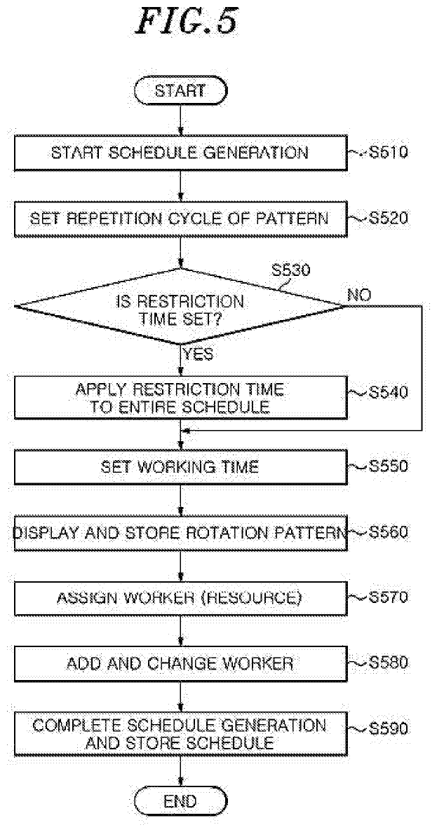

FIG. 5 is a flowchart illustrating another example of an enhanced schedule generation method based on a rotation pattern according to an example embodiment. A method of generating a new schedule instead of calling a prestored rotation pattern template is described with reference to FIG. 5.

In operation S510, a schedule generation process may be started using a schedule manager terminal.

In operation S520, a repetition cycle of a rotation pattern in which a working pattern is repeated may be set.

In operation S530, restriction time information may be set prior to setting a working time of the working pattern. Also, without separately setting a restriction time, a working day, a shift working time and an off time may be set during setting of the working time.

When setting of a restriction time is not required, operation S550 of setting a working time may be directly performed. When the setting of the restriction time is required, the restriction time may be applied to the entire schedule in operation S540.

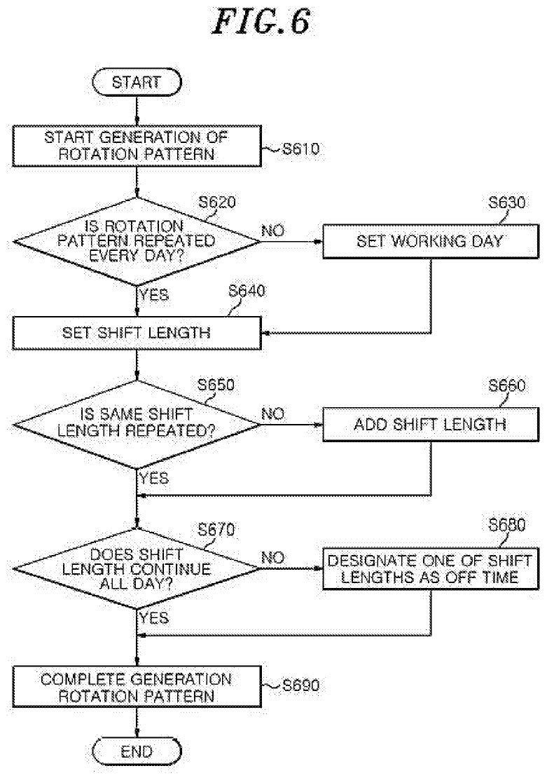

In operation S550, a working time may be set with respect to the repetition cycle. In operation S550, one or more shift working times, intensive working time information, and the like may be set. A working time setting process will be further described below with reference to FIG. 6.

In operation S560, a rotation pattern including a repetition pattern of a time block may be generated based on the set repetition cycle and the set working time, and may be displayed on a manager terminal. A manager may verify the generated rotation pattern, and may change the rotation pattern, if necessary.

In operation S570, at least one worker may be assigned to the generated rotation pattern. For example, one worker may be assigned to one time block, or a plurality of workers or a specific group may be assigned to one time block.

In operation S580, a worker may be added or changed based on a checking result of the validity checker 360 or if necessary prior to determining of a final schedule.

In operation S590, a schedule including at least one rotation pattern may be generated and stored.

FIG. 6 is a flowchart illustrating an enhanced rotation pattern generation method according to an example embodiment.

When a generation of a rotation pattern is started in operation S610, whether the rotation pattern is repeated every day may be determined in operation S620. When the rotation pattern is not repeated every day, a working day may be set in operation S630. For example, weekdays from Monday to Friday may be set as working days, or Monday, Wednesday and Friday may be designated as a 3-day workweek. Also, Tuesday, Thursday, and Saturday may be set as working days.

In operation S640, a shift length that refers to a number of working hours of a corresponding worker is performed, may be set. In operation S650, whether the same shift length is repeated may be determined first when the shift length is set. For example, when the same shift length is repeated, a double 12-hour shift, or a three 8-hour shift may be set by inputting only a shift length. When the same shift length is not repeated, one or more shift lengths may be added in operation S660. For example, when shift lengths are 16 hours and 8 hours, a length of 16 hours may be input as a first shift length, and a length of 8 hours may be additionally input as a second shift length.

In operation S670, whether the shift length continues 24 hours a day may be determined. When working continues for 24 hours without an off time, the generation of the rotation pattern may be completed without an input of an off time in operation S690. When an off time exists, one of shift lengths may be designated as an off time in operation S680. For example, when a working time is 16 hours, and when an off time is 8 hours, a length of 16 hours and a length of 8 hours may be input as shift lengths, and 8 hours may be designated as an off time, to complete the generation of the rotation pattern.

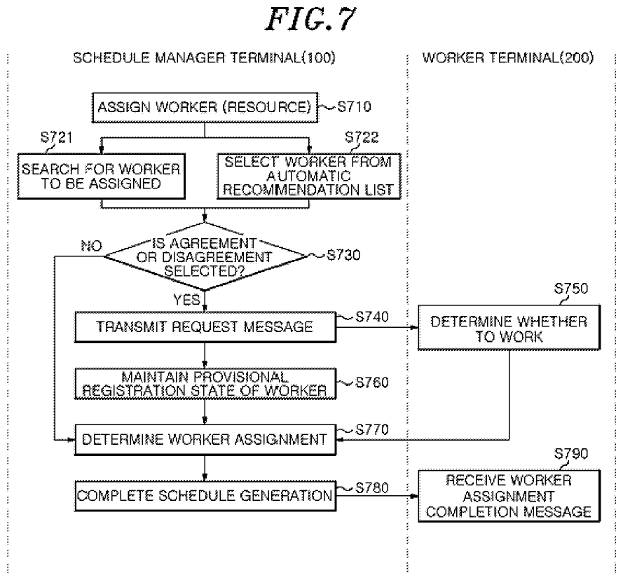

FIG. 7 is a flowchart illustrating a process of assigning a worker (resource) according to an example embodiment.

Referring to FIG. 7, a process of assigning a worker to a set rotation pattern includes a process of assigning a worker in the schedule manager terminal 100 accessed by a schedule manager, and a process of receiving and checking a message associated with an approval and an assignment of a work in the worker terminal 200 accessed by an assigned worker.

In operation S710, the process of assigning a worker (resource) may be started by the schedule manager terminal 100. Operation S721 of searching for a worker to be assigned, and operation S722 of selecting a worker from an automatic recommendation list that automatically recommends an appropriate worker may be simultaneously or alternatively performed.

In operation S730, a manager may allow a worker to select an agreement or a disagreement during the process. When the agreement or the disagreement is not selected, a worker assignment may be determined immediately without waiting for a worker's approval in operation S770.

When the agreement or the disagreement is selected, a request message for a worker assignment may be transmitted to the worker terminal 200 in operation S740. In operation S750, a worker may determine whether to work, based on the request message using the worker terminal 200. Before the worker determines whether to work, a provisional registration state of the worker may be maintained in the schedule manager terminal 100 in operation S760. When operation S750 is completed, an assignment of the worker may be determined in operation S770.

In operation S780, a schedule generation may be finally completed through the above worker assignment process. In operation S790, a worker assignment completion message may be transmitted to the worker terminal 200, and the worker may confirm a work schedule based on the received worker assignment completion message.

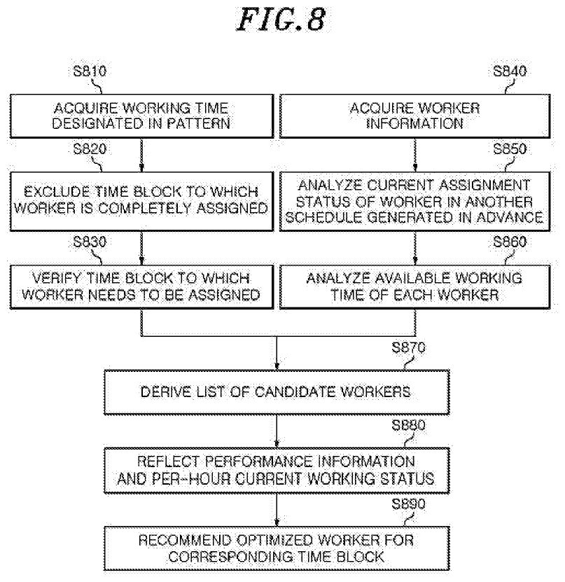

FIG. 8 is a flowchart illustrating a process of recommending a worker to be assigned to a rotation pattern according to an example embodiment. A worker recommendation process may be performed in the optimizer 350 of the schedule management server 300.

In operation S810, a working time designated in a rotation pattern may be acquired. In operation S820, a time block to which a worker is already completely assigned may be excluded. In operation S830, a time block to which a worker needs to be assigned may be verified.

Also, in parallel with operations S810 through S830, worker information including, for example, shift working time information, a working time of a worker, and the like, may be acquired in operation S840, a current assignment status of a corresponding worker may be analyzed in another schedule that is generated in advance, in operation S850, and an available working time of each worker, that is, a time available for a work assignment, may be analyzed in operation S860.

By verifying the time block to which a worker needs to be assigned in operation S830 and by analyzing the available working time of each worker in operation S860, a list of available candidate workers may be derived in operation S870. To assign a more appropriate worker of the list of the candidate workers, a worker may be recommended by reflecting performance information, a per-hour current working status, and the like, in operation S880. For example, the performance information may include an index, such as, a mean time to acknowledge (MTTA), or a mean time to resolve (MTTR).

In operation S890, an optimized worker determined to be most suitable for a corresponding time block may be recommended through the above process. As described above, rotation pattern information, working pattern information of a worker and performance information may be compared and analyzed, and thus it is possible to automatically recommend an optimal worker who is to be assigned to a rotation pattern. The above automatic worker recommendation result may be displayed and provided on the schedule manager terminal 100 accessed by a schedule manager.

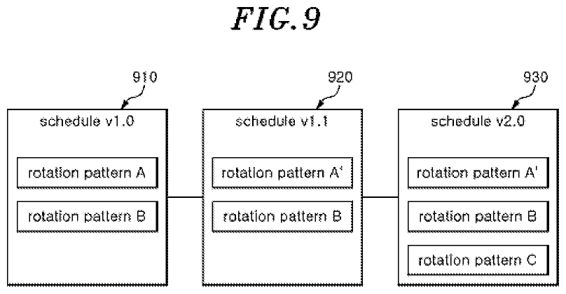

FIG. 9 is a diagram illustrating a unit of storage of a schedule according to an example embodiment.

Schedules that continue to be updated and stored over time may be classified as schedule v1.0 910, schedule v1.1 920, schedule v2.0 930 by versions, and may be stored.

The schedule v1.0 910 may be configured to include a rotation patterns A and a rotation pattern B. The schedule v1.1 920 that is newly updated may include a revised rotation pattern A′ generated by revising the rotation pattern A. and the rotation pattern B. The schedule v2.0 930 may include a rotation pattern C that is newly added, in addition to the revised rotation pattern A′ and the rotation pattern B.

The above revision of a schedule may be stored in a unit of a schedule, and a template included in a schedule may be stored in a unit of a rotation pattern. Thus, prestored rotation patterns may be provided as templates in various versions, to reduce a possibility of an occurrence of an error of a user when a schedule is generated and to provide a convenient and intuitive accessibility, and a user designation option may be selectively provided to allow a user to perform a task using various methods by providing the user with the initiative.

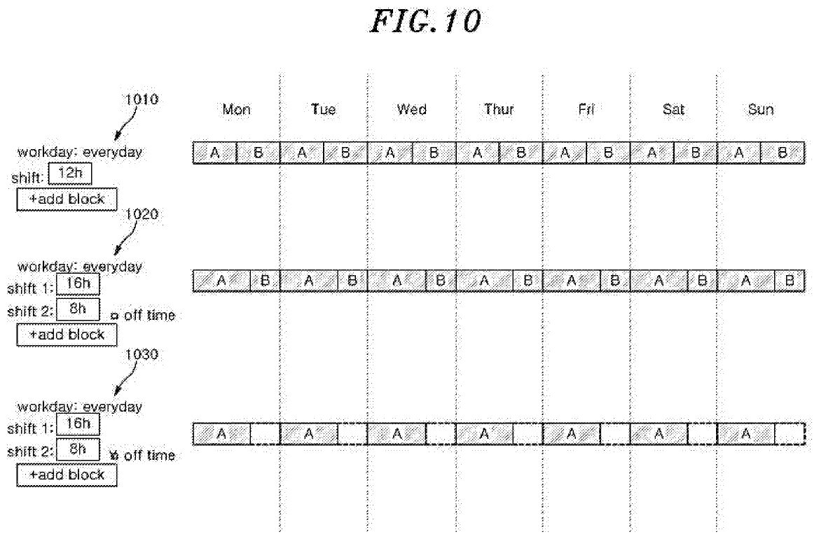

FIG. 10 illustrate screens for setting a shift working time and an off time according to an example embodiment.

Referring to FIG. 10, a repetition cycle of a rotation pattern is set to one week from Monday to Sunday, and working days are set to everyday without a holiday.

In a first setting screen 1010, a shift working time (work cycle) is set to 12 hours, and 24 hours a day is equally split in half. Workers A and B may be repeatedly assigned for each time block.

In a second setting screen 1020, two different shift working times are set to 16 hours and 8 hours, respectively. To input a shift working time, “16h” may be input as a first shift working time shift 1, a block addition button “+add block” may be input, and “8h” may be input as a second shift working time shift 2. The above block addition button may be used to easily input two or more shift working times or a shift length. Also, a length of each time block may be determined based on a working time, and thus it is possible to intuitively determine a difference between working times by displaying a difference between lengths of time blocks to which the workers A and B are assigned.

In a third setting screen 1030, two shift working times, e.g., “16h” and “8h” are input. Also, an off time box is marked with a check mark, and accordingly a second shift working time shift 2 “8h” is deactivated and displayed as a blank indicating that working is not performed. When an off time is included in a pattern, as described above, instead of a pattern that continues all day, the pattern may be set using an off time input and off time checking button.

By a method of generating a rotation pattern according to an example embodiment as described above, it is possible to store a repetition pattern of a time block as a template and reuse the repetition pattern, and possible to easily generate a desired pattern instead of using a plurality of layers.

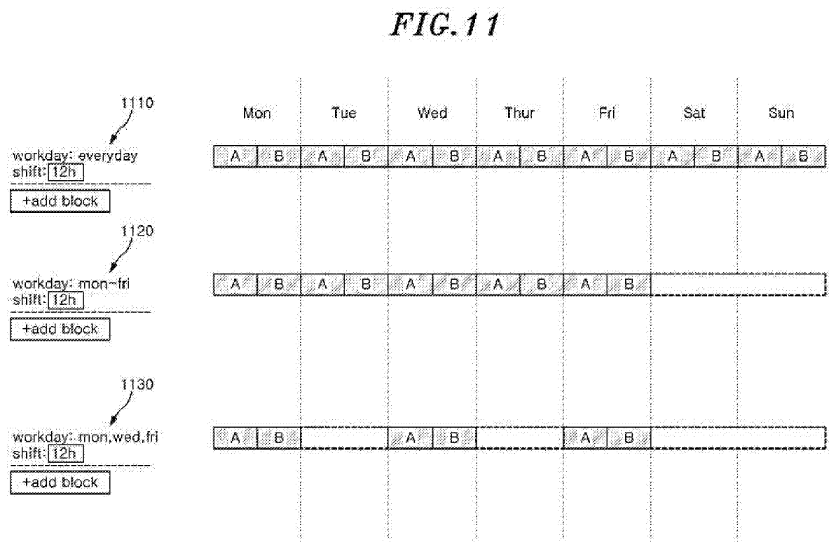

FIG. 11 illustrate screens for setting working days in an equal split rotation pattern according to an example embodiment.

Referring to FIG. 11, a repetition cycle of a rotation pattern is set to one week from Monday to Sunday. and two workers, for example, workers A and B are set. Also, a constant shift working time (shift length) is set to 12 hours, and accordingly the rotation pattern is split into equal time blocks.

In a first setting screen 1110, when working days are set to everyday without a holiday, and when a shift working time is set to 12 hours, workers A and B may be automatically and sequentially assigned. Thus, it is possible to simply complete a rotation pattern may be simply completed by merely inputting a pattern cycle, a shift working time and a worker.

In a second setting screen 1120, working days are set to weekdays from Monday to Friday, and accordingly time blocks corresponding to Saturday and Sunday are deactivated. Similarly, when a shift working time is set to 12 hours, workers A and B may be automatically and sequentially assigned every day. Thus, it is possible to simply complete a rotation pattern by merely inputting a pattern cycle, a working day, a shift working time and a worker.

In a third setting screen 1130, working days are designated as Monday, Wednesday and Friday, instead of daily or weekday, and time blocks other than time blocks corresponding to Monday, Wednesday, and Friday are deactivated. When a shift working time is set to 12 hours, workers A and B may be automatically and sequentially assigned to designated days only. Thus, it is possible to simply complete a rotation pattern by merely inputting a pattern cycle, a working day, a shift working time and a worker.

While the enhanced schedule management method and apparatus based on the rotation pattern according to various example embodiments have been described above, it should be understood that they have been presented by way of example only, and not limitation. It will be understood by one of ordinary skill in the art that various changes in form and details may be made therein without departing from the scope of the invention as defined in the appended claims. Therefore, the scope of the disclosure is defined not by the detailed description, but by the claims and their equivalents, and all variations within the scope of the claims and their equivalents are to be construed as being included in the disclosure.

1. A schedule management method based on a rotation pattern, the schedule management method comprising:
setting a repetition cycle in which a working pattern is repeated based on an input of the repetition cycle on a schedule manager terminal;
displaying, on the schedule manager terminal, a first box configured to receive a first working time;
setting the first working time with respect to the repetition cycle based on input of the first working time to the first box;
generating a rotation pattern including a plurality of first time blocks repeated based on the repetition, the length of each of the first time blocks being proportional to the first working time;
displaying, on the schedule manager terminal, the rotation pattern including the plurality of the first time blocks cycle in response to the input of the first working time;
displaying, on the schedule manager terminal, a second box configured to receive a second working time in response to activation of a block addition button on the schedule manager terminal;
setting the second working time with respect to the repetition cycle based on input of the second working time to the second box, the first working time being different from the second working time;
displaying, on the schedule manager terminal, updated rotation pattern including the plurality of the first time blocks and a plurality of second time blocks, each of the plurality of second time blocks being displayed next to each of the plurality of first time blocks in response to the input of the second working time, and the length of each of the second time blocks being proportional to the second working time;
assigning at least one worker to ones of the first time blocks and the second time blocks of the rotation pattern; and
generating a schedule including at least two rotation patterns including the generated rotation pattern.

2. The schedule management method of claim 1, further comprising:
storing the generated rotation pattern as a template; and
calling at least one of a plurality of rotation patterns that are stored.

3. The schedule management method of claim 1, wherein the generating of the rotation pattern comprises:
setting a working day based on whether the rotation pattern is repeated every day;
adding a shift working time based on whether the same length of the shift working time is repeated; and
designating an off time.

4. (canceled)

5. (canceled)

6. The schedule management method of claim 1, further comprising:
determining a suitability of a candidate worker by comparing information of the rotation pattern and a working pattern of the candidate worker.

7. The schedule management method of claim 1, further comprising:
searching for a time block to which a worker is not assigned from time blocks of the rotation pattern, and searching for a candidate worker corresponding to the time block to which the worker is not assigned.

8. The schedule management method of claim 7, further comprising:
transmitting a notification message to a terminal of the candidate worker and receiving information about an approval or a refusal from the terminal of the candidate worker.

9. The schedule management method of claim 1, further comprising:
setting intensive working time information; and
determining whether a worker is changed within an intensive working time.

10. The schedule management method of claim 1, further comprising:
searching for a time block filled with overtime working hours of a worker from time blocks of the rotation pattern, and searching for a worker substituted for the worker who works overtime.

11. A schedule management apparatus based on a rotation pattern, the schedule management apparatus comprising:
a pattern cycle setter configured to set a repetition cycle in which a working pattern is repeated based on an input of the repetition cycle on a display of the schedule management apparatus;
a working time setter configured to:
display, on the display of the schedule management apparatus, a first box configured to receive a first working time;
set the first working time with respect to the repetition cycle based on an input of the first working time to the first box;
display, on the display of the schedule management apparatus, a second box configured to receive a second working time;
set the second working time with respect to the repetition cycle based on an input of the second working time to the second box, the first working time being different from the second working time;
a rotation pattern generator configured to:
generate a rotation pattern including a plurality of first time blocks repeated based on the repetition cycle, the length of each of the first time blocks being proportional to the first working time;
display, on the display of the schedule management apparatus, the rotation pattern including the plurality of the first time blocks in response to the input of the first working time; and
display, on the display of the schedule management apparatus, updated rotation pattern including the plurality of the first time blocks and a plurality of second time blocks, each of the plurality of second time blocks being displayed next to each of the plurality of first time blocks in response to the input of the second working time, the length of each of the second time blocks being proportional to the second working time;
an optimizer configured to assign at least one worker to ones of the first time blocks and the second time blocks of the rotation pattern.

12. The schedule management apparatus of claim 11, further comprising:
a rotation pattern storage configured to store the generated rotation pattern as a template,
wherein the rotation pattern storage is configured to call at least one of a plurality of rotation patterns that are stored.

13. The schedule management apparatus of claim 11, wherein the working time setter is configured to set a working day based on whether the rotation pattern is repeated every day, to add a shift working time based on whether the same length of the shift working time is repeated, and to designate an off time.

14. (canceled)

15. (canceled)

16. The schedule management apparatus of claim 11, wherein the optimizer is configured to assign, to the time block, a working time of a mappable candidate worker based on information of the rotation pattern.

17. The schedule management apparatus of claim 11, further comprising:
a validity checker configured to search for a time block to which a worker is not assigned from time blocks of the rotation pattern, and to search for a candidate worker corresponding to the time block to which the worker is not assigned.

18. The schedule management apparatus of claim 17, wherein the optimizer is configured to transmit a notification message to a terminal of the candidate worker and to receive information about an approval or a refusal from the terminal of the candidate worker.

19. The schedule management apparatus of claim 11, further comprising:
a validity checker configured to determine whether a worker is changed within an intensive working time,
wherein the working time setter is configured to set intensive working time information.

20. The schedule management apparatus of claim 11, further comprising:
a validity checker configured to search for a time block filled with overtime working hours of a worker from time blocks of the rotation pattern, and to search for a worker substituted for the worker who works overtime.

21. The schedule management method of claim 1, further comprising:
displaying, on the schedule manager terminal, updated rotation pattern including the plurality of the first time blocks and a plurality of blank blocks in response to an activation of an off time box.

22. The schedule management apparatus of claim 11, wherein the working time setter is configured to display, on the schedule manager terminal, updated rotation pattern including the plurality of the first time blocks and a plurality of blank blocks in response to an activation of an off time box.
